(19) United States
(12) Patent Application Publication
(10) Pub. No.: US 2026/0155913 A1
(43) Pub. Date: Jun. 4, 2026

(54) SYSTEMS AND METHODS FOR IMPROVING VOICE CALL QUALITY AND DEVICE LATENCY

(71) Applicant: Google LLC, Mountain View, CA (US)

(72) Inventor: Sunil KUMAR, Cupertino, CA (US)

(73) Assignee: Google LLC, Mountain View, CA (US)

(21) Appl. No.: 19/104,992

(22) PCT Filed: Jul. 17, 2023
(86) PCT No.: PCT/US2023/027916

§ 371 Date: Feb. 19, 2025

Related U.S. Application Data
(60) Provisional application No. 63/400,810, filed on Aug. 25, 2022.

(51) Int. Cl. H04L 1/08

(52) U.S. Cl. CPC H04L 1/08

(57) ABSTRACT

Features described herein generally relate to systems and methods for improving voice call quality and device latency. A communication technique is disclosed in which a primary earbud of a set of earbuds acknowledges successful reception of the voice packet from a source device and transmits a data packet to a secondary earbud of set of earbuds when the secondary earbud is unable to successfully intercept and/or acquire the voice packet. Even if the secondary earbud does not intercept and/or otherwise acquire voice packet in a transmission from the source device to the primary earbud, the secondary earbud can receive the voice packet thereby improving voice call quality even in poor link conditions.

### CROSS-REFERENCES TO RELATED APPLICATIONS

This application claims priority to, and the benefit of U.S. Provisional Patent Application No. 63/400,810, filed Aug. 25, 2022, the entire disclosure of which is incorporated by reference in its entirety for all purposes.

### BACKGROUND

Short-range wireless technologies such as Bluetooth, have enabled extended and remote functionality between devices. As such, users have come to rely on these technologies and expect seamless, glitch-free, and otherwise high-quality experiences while using their Bluetooth-enabled devices. These technologies continue to grow in popularity and, as more devices incorporate these technologies, bandwidth allocation between devices is challenging.

### SUMMARY

Embodiments described herein pertain to systems and methods for improving voice call quality and device latency.

In various embodiments, a method for controlling a set of earbuds includes: receiving, by a first earbud of the set of earbuds from a device using a first wireless link in a set of connection intervals of a plurality of connection intervals, a plurality of downstream packets; and transmitting, from the first earbud to the device using the first wireless link in the set of connection intervals, a plurality of upstream packets, wherein a first upstream packet of the plurality of upstream packets comprises an indication that a first downstream packet of the plurality of downstream packets was properly received by the first earbud, and wherein a second upstream packet of the plurality of upstream packets comprises an indication that a second downstream packet of the plurality of downstream packets was not properly received by the first earbud.

In some embodiments, the first wireless link is a Bluetooth Basic Rate/Enhanced Data Rate (Bluetooth BR/EDR) link.

In some embodiments, the method further includes: determining, by the first earbud and a second earbud of the set of earbuds, that the second earbud has not acquired the first downstream packet; and in response to determining that the second earbud has not acquired the first downstream packet, transmitting, from the first earbud to the second earbud using a second wireless link, a data packet corresponding to the first downstream packet.

In some embodiments, the second wireless link is a Bluetooth Low Energy link.

In some embodiments, each upstream packet of the plurality of upstream packets comprises voice information of a user participating in a voice call using the set of earbuds.

In some embodiments, each downstream packet of the plurality of downstream packets is received in a first slot of a plurality of slots of each connection interval of the set of connection intervals.

In some embodiments, each upstream packet of the plurality of upstream packets is transmitted in a second slot of the plurality of slots of each connection interval of the set of connection intervals, the second slot of a respective connection interval of the set of connection intervals adjacent to the first slot of the respective connection interval.

Some embodiments include a system that includes a processing system and at least one computer-readable medium storing instructions which, when executed by the processing system, cause the system to perform part or all of the operations and/or methods disclosed herein.

Some embodiments include a non-transitory computer-readable medium storing instructions which, when executed by a processing system of an earbud, cause the earbud to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates an embodiment of an audio system.

FIG. 1B illustrates another embodiment of an audio system.

FIG. 2 illustrates an embodiment of a block diagram of an audio system that includes a pair of true wireless earbuds communicating with an audio source.

FIG. 3 illustrates an embodiment of cross-body attenuation resulting in communication between an audio source and a first earbud experiencing more attenuation than communication between the audio source and the second earbud.

FIG. 4 illustrates an embodiment of an audio system in which true wireless earbuds communicate with each other in addition to communicating with an audio source.

FIG. 5A illustrates an embodiment of communication between a call gateway and true wireless earbuds during a voice call.

FIG. 5B illustrates another embodiment of communication between a call gateway and true wireless earbuds during a voice call.

FIG. 6 illustrates an embodiment of communication between a call gateway and multiple accessory devices during a voice call.

FIG. 7A illustrates another embodiment of communication between a call gateway and true wireless earbuds during a voice call.

FIG. 7B illustrates another embodiment of communication between a call gateway and multiple accessory devices during a voice call.

FIG. 8A illustrates another embodiment of communication between a call gateway and true wireless earbuds during a voice call.

FIGS. 8B-8D illustrate another embodiment of communication between a call gateway and multiple accessory devices during a voice call.

FIG. 9 illustrates an embodiment of a method corresponding to the embodiments of FIGS. 7A and 7B.

FIG. 10 illustrates an embodiment of a method corresponding to the embodiments of FIGS. 8A-8D.

### DETAILED DESCRIPTION

Wireless audio playback devices such as true wireless earbuds offer a convenient way for users of electronic devices to participate in phone calls made by the electronic devices. For example, a user can initiate a phone call using an electronic device (e.g., a mobile phone, a personal computer, and the like) and use true wireless earbuds to participate in the call without physically holding the electronic device in their hands. In a typical scenario, once a call is initiated on the electronic device, a first audio signal corresponding to the call is transmitted from the electronic device to the earbuds where a speaker of the earbuds outputs the received audio to the user, and a second audio signal corresponding to the call is received at a microphone of the earbuds and transmitted to the electronic device. True wireless earbuds often communicate with the electronic device using a short-range wireless technology that utilizes a Bluetooth-family communication protocol, such as Bluetooth Classic or Bluetooth LE. Often a user will use Bluetooth-based wireless communications concurrently for true wireless earbuds and multiple accessory devices such as a keyboard and mouse used to control their electronic device. Such an arrangement allows for simultaneously participation in calls initiated by the electronic device and perform other tasks with the electronic device such as surfing the Internet using the keyboard and mouse.

To enable such functionality, the electronic device or call gateway connects to and transmits a voice packet to a first earbud (i.e., the primary earbud). While the call gateway does not connect to the second earbud, the second earbud intercepts and/or otherwise acquires the voice packet transmitted to the primary earbud using a packet capturing technique such as sniffing. In this way, the first and second earbuds can receive the same voice packet even though the call gateway may not even be aware of the second earbud. To ensure the voice packet is received by the primary earbud, communication is configured between the primary earbud and call gateway such that the call gateway will typically transmit the voice packet multiple times even when the voice packet is successfully received by the primary earbud on the first attempt, which provides the secondary earbud multiple opportunities to receive the voice packet. This process is repeated in intervals throughout the duration of the call.

However, the foregoing arrangement leads to the following challenges. When the link condition between the call gateway and the primary earbud is good and the secondary earbud is able to acquire the voice packet transmitted to the primary earbud, bandwidth utilization at the call gateway leads to poor user experience for accessory devices connected to the call gateway during the call. For example, in the case of a keyboard or mouse, a user may experience a slow keyboard or mouse response while participating in a call using the earbuds. On the other hand, when there is a poor link condition between the call gateway and the primary earbud, the primary earbud and/or secondary earbud may be unable to intercept and/or otherwise acquire the voice packet, which, in addition to bandwidth utilization at the call gateway leading to poor user experience for accessory devices connected to the call gateway during the call, often results poor audio quality during the call.

The techniques described herein overcome these challenges and/or others by providing a communication technique for improving audio quality during voice calls and accessory device latency. As described above, during a voice call, communication between the primary earbud and the call gateway is configured such that the call gateway will transmit the voice packet to the primary earbud multiple times even after the primary earbud has successfully received the voice packet. The techniques described herein provide a communication technique in which the primary earbud acknowledges successful reception of the voice packet from a source device and transmits a data packet to the secondary earbud when the secondary earbud is unable to successfully intercept and/or acquire the voice packet. In this way, even if the secondary earbud does not intercept and/or otherwise acquire voice packet in a transmission from the call gateway to the primary earbud, the secondary earbud can receive the voice packet thereby improving voice call quality even in poor link conditions. In an implementation, the primary earbud acknowledges reception of the voice packet as soon as the voice packet is successfully received by the primary earbud. In another implementation, the primary earbud periodically acknowledges reception of the voice packet if it is successfully received in an interval. In this way, by acknowledging successful reception of a voice packet by the primary earbud, bandwidth utilization at the source device can be reduced thereby enabling the source device to improve latency of accessory devices connected to the source device.

“True wireless earbuds,” as used herein, refer to earbuds that both: 1) receive audio packets (e.g., voice packets) wirelessly from one or more audio sources; and 2) are not physically connected with each other, such as via a wire. Therefore, in a pair of true wireless earbuds, each earbud must have its own power supply and wireless communication interface to allow for communication. As described herein, embodiments of earbuds, unless otherwise noted, are directed to true wireless earbuds. Additionally, while the techniques described herein are described with respect to communication between a call gateway device and among earbuds, it should be understood that at least some techniques described herein can have additional applicability. For example, communication techniques described herein could be used in arrangements including one or more computing devices such as one or more smart display and wireless stereo speakers to improve performance.

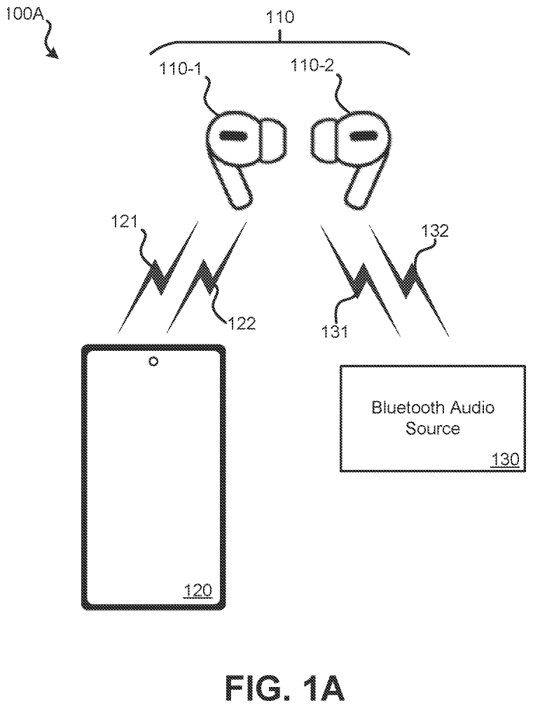

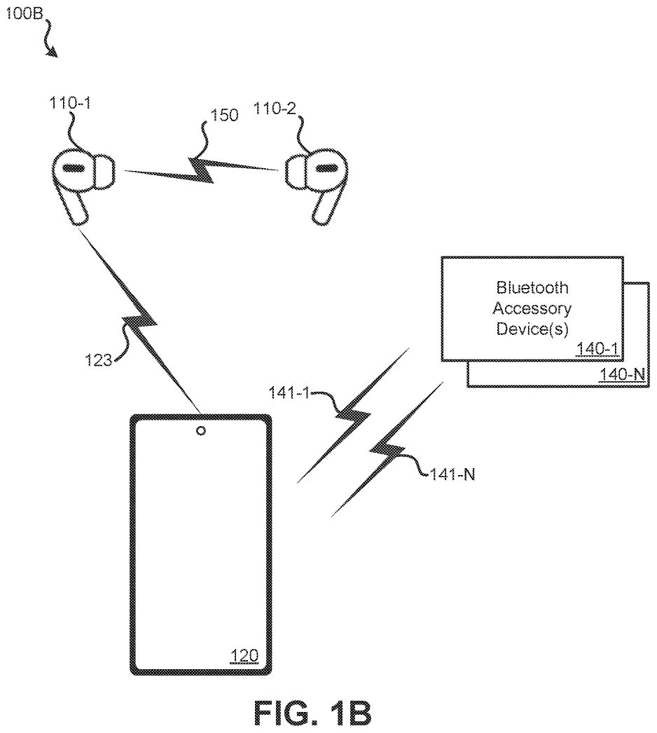

FIGS. 1A and 1B illustrate embodiments of an audio system. As shown in FIG. 1A, audio system 100A can include earbuds 110 (which can include earbud 110-1 and earbud 110-2), audio source 120, and audio source 130, and, as shown in FIG. 1B, audio system 100B can include earbuds 110, audio source 120, and accessory devices 140 (which can include multiple accessory devices 140-1, . . . 140-N). Although not shown, audio system 100A can also include accessory devices such as accessory devices 140. Similarly, audio system 100B can also include additional audio sources such as audio source 130.

Audio source 120 can represent various forms of computerized devices capable of Bluetooth communications. As illustrated, one possible form of audio source 120 is a smartphone. For example, a smartphone can output stereo audio (e.g., music, gaming audio, audio for an audio or video conference) and mono audio (e.g., audio for a telephone call, mono audio for an audio or video conference). Many other forms of audio source 120 may be possible, such as: a tablet computer, a gaming device, a laptop computer, a desktop computer, a stereo system, and a television. More generally, any computerized device that outputs Bluetooth audio can serve as audio source 120. In some embodiments, audio source 120, when used for voice phone calls, can alternatively be used as and referred to as a call gateway. (In voice call terminology, earbuds 110 can be referred to as a “call terminal.”)

In general, Bluetooth-family protocols are used as the short-range wireless technology standards for exchanging data between audio source 120 (and possibly audio source 130) and earbuds 110 and between audio source 120 and accessory devices 140. Within the Bluetooth-family, various versions of Bluetooth may be used, depending on the particular embodiment. Bluetooth Basic Rate/Enhanced Data Rate (Bluetooth BR/EDR), which is also referred to as Bluetooth “Classic,” can be used in various embodiments as detailed herein. Some embodiments detailed herein rely on Bluetooth Low Energy (LE) or LE Audio as the specific Bluetooth-family protocol for communication. The same hardware may be used to implement any of these Bluetooth-family protocols.

Depending on the version of Bluetooth that is used, one or more Bluetooth profiles may be used to define a connection/communication protocol between a central (or first) device and peripheral (or second) device(s) and between peripheral devices. For example, the connection/communication protocol between the audio source 120 and earbuds 110 may be defined by the Advanced Audio Distribution Profile (A2DP) and/or the Hands-Free Profile (HFP). Similarly, the connection/communication protocol between the audio source 120 and the accessory devices 140 may be defined by the Human Interface Device (HID) Profile. The foregoing profiles are not intended to be limiting and the various embodiments described herein can use other Bluetooth profiles such as the Headset Profile (HSP) and the Mesh Profile (MESH).

Further, embodiments detailed herein may use one or more of these Bluetooth-family protocols as a starting point but may have additional features that go beyond the specification of the standard. These additional features require both an audio source and earbuds that are compatible with the additional features to be used in order for the additional features to be available. As an example, one manufacturer may produce earbuds and audio sources (e.g., smartphones, laptop computers, tablet computers) that support additional features that go beyond the minimum features of a Bluetooth-family protocol when used together. However, when one of such devices is used with another manufacturer's devices, such additional features beyond the Bluetooth-family may not be available unless the manufacturers have cooperated on implementing the additional features.

While the embodiments detailed herein are focused on improvements to Bluetooth-family protocols, it should be understood that the embodiments detailed herein can also be applied to other short-range wireless technologies that could be used to enable communication between devices. For example, the embodiments detailed herein are equally applicable to the following technologies: infrared data association (IrDA); radio frequency identification (RFID); wireless local access network (WLAN); near field communication (NFC); ZigBee; Z-wave; wireless fidelity (Wi-Fi) and wireless fidelity direct (Wi-Fi Direct); ultra-wideband (UWB); ANT and ANT+; third generation (3G), fourth generation (4G), fifth generation (5G), and sixth generation (6G), and the like.

As illustrated in FIG. 1A, separate data streams may be used between an audio source and each earbud of earbuds 110. In a Bluetooth LE or LE Audio scenario, a connected isochronous stream (CIS) or broadcast isochronous stream (BIS) may be present on link 121 from audio source 120 to earbud 110-1. A separate CIS or BIS may be present as part of link 122 to earbud 110-2. If audio is being transmitted from an earbud of earbuds 110 to audio source 120 (e.g., from a microphone of an earbud for a phone call), another CIS or BIS may be present from an earbud to audio source 120. Alternatively, the same CIS or BIS can be used for transmitting microphone audio from an earbud to audio source 120. Separate CISs or BISs may also exist as part of wireless communications 131 and wireless communications 132 between an additional audio source such as audio source 130 and earbuds 110. Separately, between each audio source and each earbud, can be another channel, referred to as an asynchronous connection-oriented link (ACL) that allows for control data to be transmitted between the audio source and the particular earbud in both directions.

While one or more active communication channels are present between audio source 120 and earbuds 110, one or more separate active communication channels can be present between earbuds 110 and audio source 130. Again here many other audio sources may be possible, such as: a tablet computer, a gaming device, a laptop computer, a desktop computer, a computerized music device, a stereo system, a television, or any computerized device that can output Bluetooth audio can serve as audio source 130.

Various use cases exist where it can be beneficial to a user for earbuds 110 to have communication channels with multiple audio sources. For example, earbuds 110 may receive audio from a computer (e.g., as audio source 120) for a video conference, but the user may desire to allow his smartphone (e.g., as audio source 130) to output notifications that are played instead of or over the audio for the video conference. As another example, a user may be listening to music via their smartphone (e.g., as audio source 120), while listening to the music, the user may be in a public place that outputs auditory notifications via Bluetooth, such as flight notifications at an airport. A computerized system of the airport may function as audio source 130 which causes flight notifications to be output instead of or over the audio being streamed to earbuds 110 by audio source 120.

Notably, audio source 130 may not be present in many embodiments or may only be intermittently present. Referring to the previous example, after leaving the airport (or perhaps disabling notifications), earbuds 110 may only receive audio from audio source 120. Other similar examples exist. For example, referring to the first example, after conclusion of the video conference, earbuds 110 may only receive audio (e.g., the auditory notifications) from their smartphone. While the example of FIG. 1 illustrates two audio sources, it may be possible for earbuds 110 to receive audio from more than two audio sources. Earbuds 110 may be configured to prioritize and/or mix audio received concurrently from different audio sources.

For mono audio (e.g., a phone call, videoconference), the audio transmitted to one or each earbud of earbuds 110 from an audio source, such as audio source 120, may be the same. For stereo audio (e.g., music playback, gaming), the audio transmitted to one or each earbud of earbuds 110 differs.

Turning to FIG. 1B, data may be transmitted between an audio source 120 and a primary earbud such as earbud 110-1 of earbuds 110 and data may be transmitted between the primary earbud 110-1 and a secondary earbud such as earbud 110-2. In a Bluetooth Classic scenario, data may be transmitted using a synchronous connection-oriented (SCO) channel or extended synchronous connection-oriented (eSCO) channel that may be present on link 123 between audio source 120 and primary earbud 110-1 and data may be transmitted using an ACL that may be present on link 150 between primary earbud 110-1 and secondary earbud 110-2. In some embodiments, the data on link 123 and/or link 150 can include audio or voice data and control data transmitted in both directions. Control data as used herein generally refers to information pertaining to the link between the audio source 120 and primary earbud 110-1 and link between primary earbud 110-1 and the secondary earbud 110-2 (e.g., physical layer properties, timing information, encryption keys, power requirements, and the like). If audio is being transmitted from an earbud of earbuds 110 to audio source 120 (e.g., from a microphone of an earbud for a phone call), the SCO or eSCO link may be used and/or another SCO or eSCO link (not shown) may be used. Separate links may also respectively exist as part of wireless communications 141-1 through wireless communications 141-N between audio source 120 and accessory devices 140-1 through 140-N. In some embodiments, these links may be a link defined by the HID Profile under the Bluetooth core specification.

While one or more active communication channels are present between audio source 120 and earbuds 110, one or more separate active communication channels can be present between audio source 120 and accessory devices 140. Accessory device 140 can represent various forms of computerized devices capable of communicating and exchanging data using Bluetooth connections. One example of an accessory device included in accessory devices 140 is a wireless keyboard and another example of an accessory device included in accessory devices 140 is a wireless mouse. Other examples of accessory devices include human interface devices, printers, scanners, network devices, gaming devices, display assistants, and the like. In general, any computerized device that can communicate using Bluetooth can serve as an accessory device included in accessory devices 140. In some embodiments, an accessory device included in accessory devices 140 can be used as and referred to as a peripheral and/or human interface device.

In some embodiments, communication between earbuds 110 and audio source 120 can be an acknowledgement, referred to as an ACK for short. An ACK can allow one of or both earbuds 110 to notify the audio source 120 that a Bluetooth packet was properly received from the audio source 120. Similarly, an ACK can allow the audio source 120 to notify one of or both earbuds 110 that a Bluetooth packet was properly received from one of or both earbuds. An ACK and data packets between earbuds can be sent using the same radio used for Bluetooth communications. At a high level, when a packet addressed to a first earbud such as earbud 110-1 is properly received by the first earbud 110-1, the first earbud 110-1 can transmit an ACK to the audio source 120. This arrangement can prevent the audio source 120 from retransmitting the packet to the earbud 110-1 and/or can allow the earbud 110-1 to transmit the packet to the second earbud 110-2 if the second earbud 110-2 cannot intercept and/or otherwise acquire the packet transmitted from the audio source 120. While an ACK is one form of communication that can occur between audio source 120 and earbuds 110, other communications detailed herein between earbuds may not involve an ACK being transmitted.

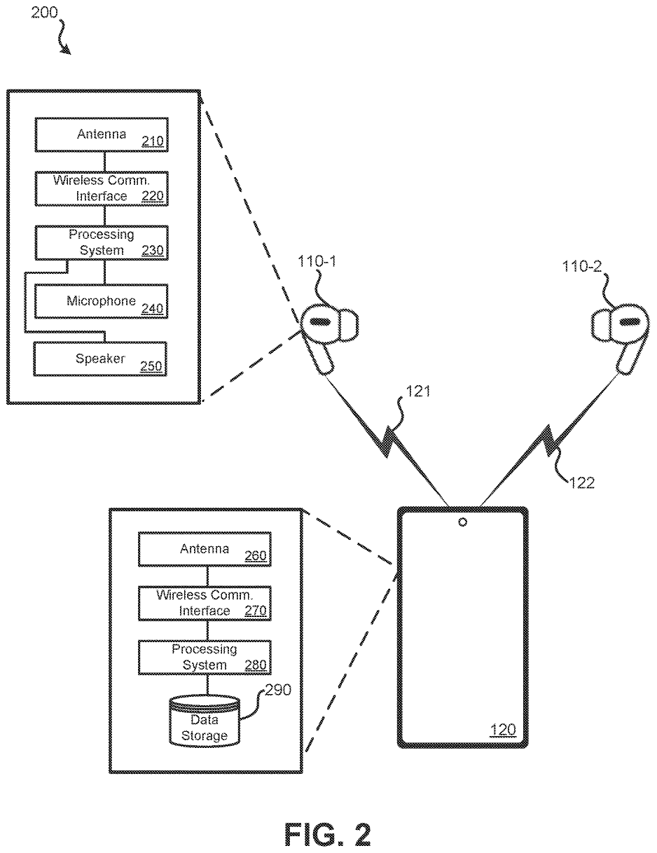

FIG. 2 illustrates an embodiment of a block diagram of an audio system 200 that includes a pair of true wireless earbuds communicating with an audio source. Audio system 200 can represent an embodiment of audio system 100A in which only a single audio source is present or audio system 100B. Audio system 200 can include earbuds 110 and audio source 120.

Referring to earbuds 110, components of earbud 110-1 can include: antenna 210; wireless communication interface 220; processing system 230; microphone 240; and speaker 250. Earbud 110-2 may have the same components. Antenna 210 can be used for receiving and transmitting Bluetooth-family communications, including BR/EDR, and LE (including LE Audio which uses LE). Wireless communication interface 220 can be implemented as a system on a chip (SOC). Wireless communication interface 220 can include a Bluetooth radio and componentry necessary to convert raw incoming data (e.g., audio data, other data) to Bluetooth packets for transmission via antenna 210. Wireless communication interface 220 may also include componentry to enable one or more alternative or additional forms of wireless communication, both with an audio source and between earbuds. Processing system 230 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored locally using one or more non-transitory processor-readable mediums, such as random-access memory (RAM), and/or flash memory. In some embodiments, processing system 230 and wireless communication interface 220 may be part of a same circuit or SOC.

In some earbuds, microphone 240 may be present. In some embodiments, each of earbuds 110 has a microphone. In other embodiments, only one of earbuds 110 has a microphone. In still other embodiments, no microphone may be present in either of earbuds 110. Audio captured using the one or more microphones of earbuds 110 can be transmitted to audio source 120. This audio, which can be referred to as “upstream” audio, may include voice, such as for use in a telephone call, video conference, gaming, etc. Various componentry (not illustrated) may be present between wireless communication interface 220, processing system 230, and microphone 240, such as an analog to digital converter (ADC) and an amplifier.

Speaker 250 converts received analog signals to audio. Various componentry (not illustrated) may be present between wireless communication interface 220, processing system 230, and speaker 250, such as a digital to analog converter (DAC) and an amplifier.

Various components of earbud 110-1 are not illustrated. In addition to the ADC, DAC, and amplifiers previously mentioned, earbud 110-1 also includes a power storage component, such as one or more batteries, and associated componentry to allow for recharging of the power storage component. Also present is a housing and componentry to hold earbud 110-1 within a user's ear. One or more non-transitory processor readable mediums can be understood as present and accessible by wireless communication interface 220, processing system 230, or both. For instance, such mediums may be used for temporary storage of data (e.g., buffers) and storing data necessary for Bluetooth communication (e.g., encryption keys).

Audio source 120 can include: antenna 260; wireless communication interface 270; processing system 280; and data storage 290. Antenna 260 can be used for receiving and transmitting Bluetooth-family communications, including BR/EDR, and LE. Wireless communication interface 270 can be implemented as a SOC. Wireless communication interface 270 can include a Bluetooth radio and componentry necessary to convert raw incoming data (e.g., audio data, other data) to Bluetooth packets for transmission via antenna 260. Wireless communication interface 270 can additionally or alternatively be used for one or more other forms of wireless communications. Processing system 280 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored locally using one or more non-transitory processor-readable mediums via data storage 290, which can include RAM, flash memory, a HDD and/or a SSD. In some embodiments, processing system 280 and wireless communication interface 270 may be part of a same circuit or SOC.

Audio source 120 can include various other components. For example, if audio source 120 is a smartphone, various components such as: one or more cameras, a display screen or touch screen, volume control buttons, other wireless communication interfaces can be present.

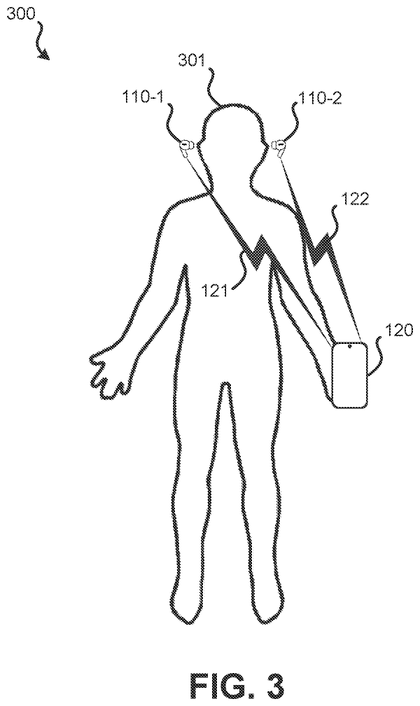

FIG. 3 illustrates an embodiment 300 of cross-body attenuation resulting in communication between an audio source and a first earbud experiencing more attenuation (or path loss) than communication between the audio source and the second earbud. In embodiment 300, user 301 is holding audio source 120 in their left hand (that is, as illustrated, user 301 is facing out of the page). Bluetooth communications occur between audio source 120 and earbud 110-2 as indicated by link 122; Bluetooth communications between audio source 120 and earbud 110-1 as indicated by link 121.

Due to audio source 120 being in the user's left hand, link 121 with earbud 110-1, which is in the user's right ear, results in wireless signals travelling through more of the user's body than link 122. Therefore, more attenuation occurs in link 121 than link 122. Accordingly, it is more likely that Bluetooth data packets exchanged between earbud 110-1 and audio source 120 may be not properly received than Bluetooth data packets exchanged between earbud 110-2 and audio source 120.

Which earbud experiences more attenuation and/or interference in its communications with an audio source can vary based on the location of audio source 120. Common places where user 301 may keep audio source 120 are: in a left hand; in a right hand; in a front left or right pocket, in a rear left or right pocket; on an arm band; in a left or right chest pocket; and on a surface or dock. Each of these locations can result in significantly different communication paths between each earbud and the antenna of the audio source and, thus, one earbud's communications can experience significantly higher interference or attenuation than the other earbud's communications.

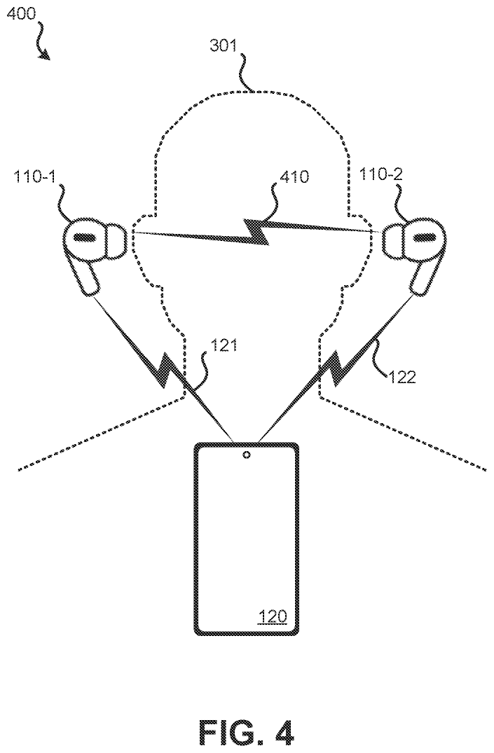

FIG. 4 illustrates an embodiment of an audio system 400 in which true wireless earbuds communicate with each other in addition to communicating with an audio source. Earbud 110-1 can perform wireless communications using cross-link 410 with earbud 110-2 and, similarly, earbud 110-2 can perform wireless communications using cross-link 410 with earbud 110-1 in some embodiments. This communication can occur via a proprietary link specific to earbuds 110 and therefore can be outside of any Bluetooth family protocol specification. The path between earbuds 110, when in use by user 301, is predictable because the distance and the object through which the signals pass (the head of user 301) remains constant. As detailed herein, the ability of earbuds 110 to communicate with each other can have significant advantages.

Cross-link 410 can use LE 2M, LE HDT (pending standardization), LE proprietary high data rate modes, classic BR/EDR, or some proprietary communication scheme. Therefore, while Bluetooth-compliant wireless communications occur between earbuds 110 and audio source 120, communications directly between earbuds do not necessarily need to be compliant with Bluetooth or any other particular communication protocol.

In some embodiments, communication between earbuds 110 can be a cross-acknowledgement, referred to as a CrossACK for short. As detailed herein, “cross-” communications refer to wireless communications transmitted directly from a first earbud and received by a second earbud. A CrossACK can allow one of earbuds 110 to notify the other earbud of earbuds 110 that a Bluetooth packet was properly received from a source device. A CrossACK and data packets between earbuds can be sent using the same radio used for Bluetooth communications. At a high level, when a packet addressed to only a first earbud is not properly received by the first earbud, but is properly received by the second earbud, the second earbud can transmit a CrossACK to the first earbud. The first earbud may then request the packet be relayed to the first earbud from the second earbud. This arrangement prevents the first earbud from having to request retransmission from the source device and/or can allow the first earbud to obtain the data from the second earbud if transmissions from the audio source continue to fail.

While a CrossACK is one form of communication that can occur between earbuds 110, other communications detailed herein between earbuds may not involve a CrossACK being transmitted.

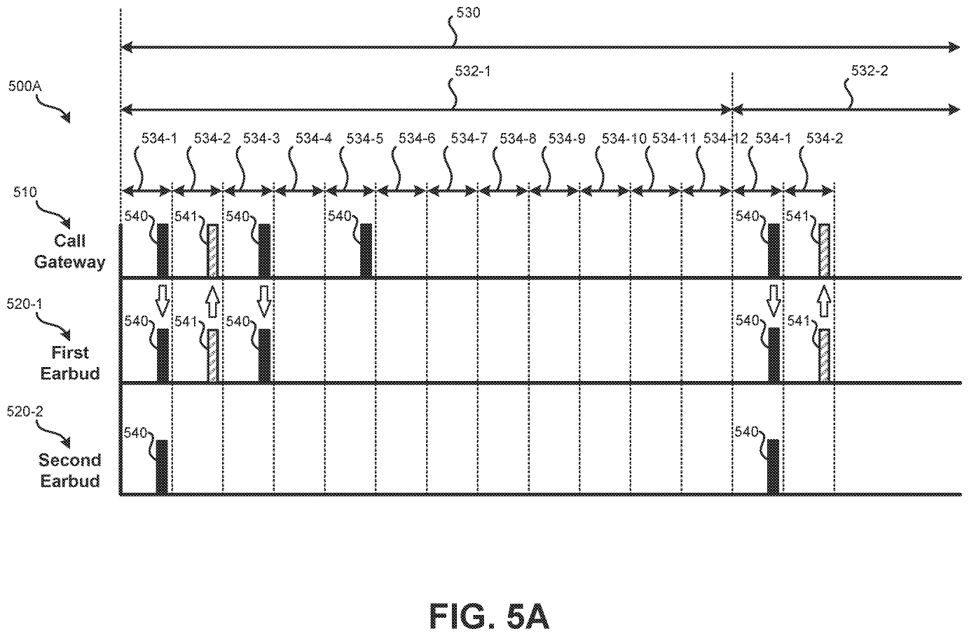

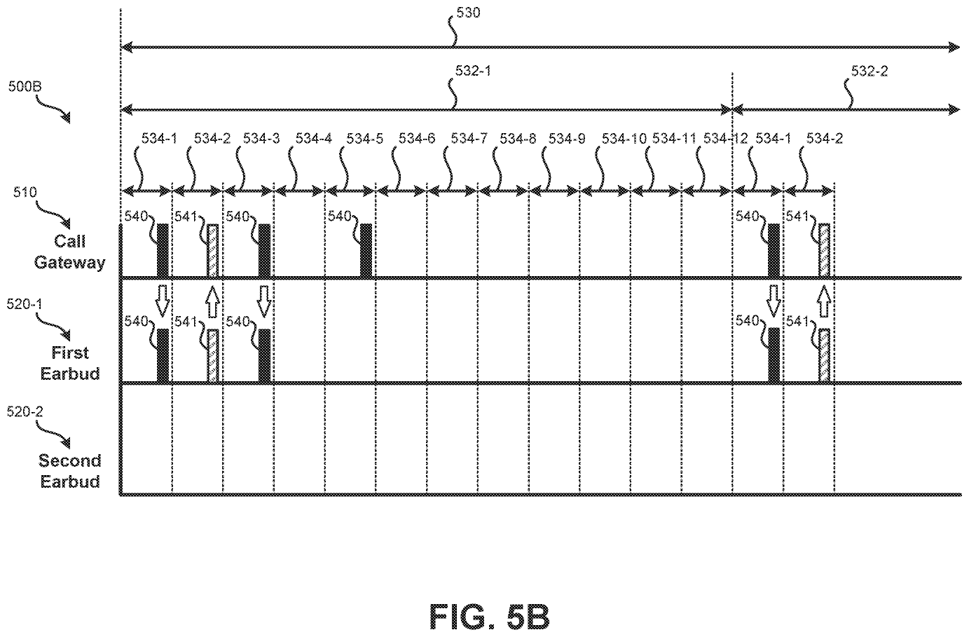

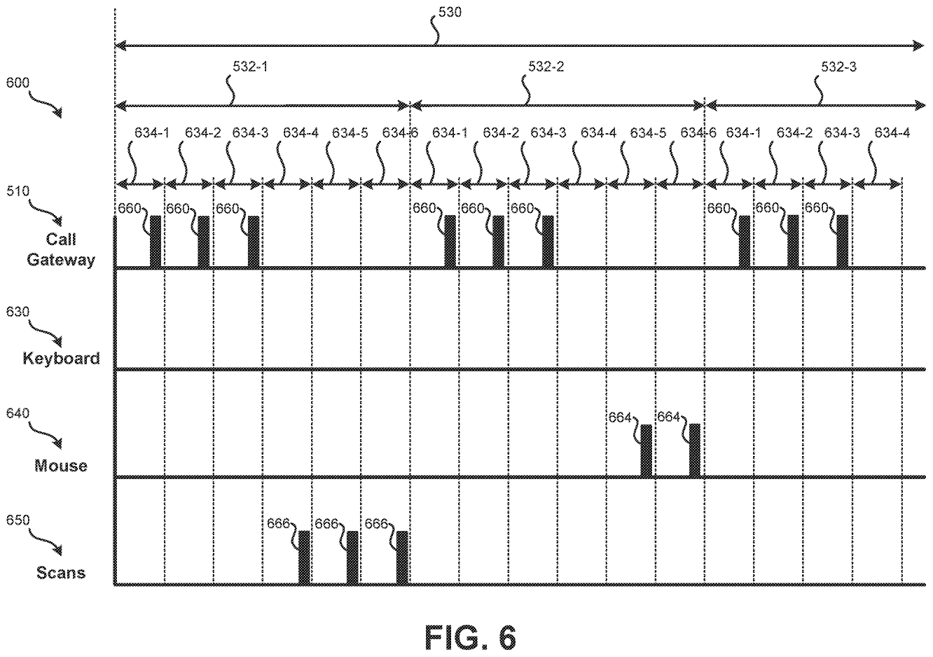

FIGS. 5A and 5B illustrate embodiments 500A, 500B of communication between a call gateway 510 and true wireless earbuds, including first earbud 520-1 and second earbud 520-2, during a voice call 530. FIG. 6 illustrates an embodiment 600 of communication between the call gateway 510 and a keyboard 630 and mouse 640 during the voice call 530. In some embodiments, the call gateway 510 can be the audio source 120, the first and second earbuds 520-1, 520-2 can be the true wireless earbuds 110, and the keyboard 630 and mouse 640 can be included in the accessory devices 140 shown in FIG. 1B. In some embodiments, the call gateway 510 can be connected to the first earbud 520-1, the keyboard 630, and the mouse 640 using a Bluetooth Classic connection and the first earbud 520-1 can be connected to the second earbud 520-2 using a Bluetooth LE connection. The foregoing arrangement is not intended to be limiting and other arrangements and short-range wireless technologies can be used.

In some embodiments, call gateway 510 can initiate the voice call 530 and a user such as 301 can participate in the voice call 530 using first and second earbuds 520-1, 520-2. During the voice call 530, the call gateway 510 and the first earbud 520-1 can be connected using an eSCO link or channel. Similarly, during the voice call 530, the call gateway 510 and the keyboard 630 and mouse 640 can be connected using a link included the HID Profile. The eSCO link can include multiple connection intervals 532 (which can include connection intervals 532-1, 532-2, 532-3, 532-4, and so on). Each connection interval 532 can span a first length of time (e.g., 7.5 milliseconds). As shown in FIGS. 5A, 5B, and 6, each connection interval 532 can be divided into multiple frames 634 (which can include frames 634-1-634-6) and each frame 634 can be further divided into two slots 534 (which can include slots 534-1-534-12). Each slot 534 can span a second length of time (e.g., 0.625 milliseconds) that is less than the first length of time. For example, a connection interval 532 that spans 7.5 milliseconds can include six frames with each framing spanning 1.25 milliseconds and including two slots each spanning 0.625 milliseconds.

Good link conditions, as used herein, refers to conditions in which the first earbud 520-1 properly receives a packet transmitted by the call gateway 510 during the voice call 530 and the second earbud 520-2 intercepts and/or otherwise acquires the transmitted packet. As such, as shown in FIG. 5A, during the voice call 530 in which good link conditions exist, the first earbud 520-1 properly receives downstream packets 540 transmitted by the call gateway 510 and the second earbud 520-2 intercepts and/or otherwise acquires the transmitted downstream packets 540. On the other hand, poor link conditions, as used herein, refers to conditions in which the first earbud 520-1 does not properly receive the packet transmitted by the call gateway 510 during the voice call 530 and/or the second earbud 520-2 cannot intercept and/or otherwise acquire the transmitted packet. As such, as shown in FIG. 5B, during the voice call 530 in which poor link conditions exist, the first earbud 520-1 properly receives downstream packets 540 transmitted by the call gateway 510, but the second earbud 520-2 cannot intercept and/or otherwise acquire the transmitted downstream packets 540.

As shown in FIGS. 5A and 5B, for a given connection interval 532, the call gateway 510 and the first earbud 520-1 can use the first slot 534 (e.g., slot 534-1 in connection interval 532-1) for the call gateway 510 to transmit a downstream packet 540 to the first earbud 520-1 and use the second slot 534 (e.g., slot 534-2 in connection interval 532-1) for the first earbud 520-1 to transmit an upstream packet 541 to the call gateway 510. In some embodiments, for the given connection interval 532, the call gateway 510 and the first earbud 520-1 can also use the third and fifth slots 534 (e.g., slots 534-3, 534-5 in connection interval 532-1) for the call gateway 510 to retransmit the downstream packet 540 to the first earbud 520-1. Similarly, for the given connection interval 532, the call gateway 510 and the first earbud 520-1 can also use fourth and sixth slots 534 (e.g., slots 534-4, 534-6 in connection interval 532-1) for the first earbud 520-1 to transmit an upstream packet 541 to the call gateway 510. In some embodiments, the first earbud 520-1 can transmit an upstream packet 541 to the call gateway 510 whenever a downstream packet 540 is properly received by the first earbud 520-1 from the call gateway 510. In other embodiments, the first earbud 520-1 can transmit an upstream packet 541 to the call gateway 510 once per connection interval 532. In some embodiments, the upstream packets 541 transmitted by the first earbud 520-1 to the call gateway 510 include negative acknowledgments (referred to as a NACK for short). An upstream packet 541 that includes a NACK can serve to indicate to the call gateway 510 that the downstream packet 540 has not been properly received by the first earbud 520-1 and that the downstream packet 540 should be retransmitted to the first earbud 520-1 in the third and/or fifth slots 534. Similarly, the call gateway 510 can treat any slot 534 reserved for an upstream packet 541 in which an upstream packet 541 is not received by the call gateway 510 in that slot 534 as an implicit NACK and retransmit the downstream packet 540 to the first earbud 520-1 in the next available slot 534 (e.g., the third and/or fifth slots). Downstream packets 540 that are retransmitted to the first earbud 520-1 after an upstream packet 541 has been properly received by the call gateway 510 can include an ACK to indicate to the first earbud 520-1 that the upstream packet 541 has been properly received by the call gateway 510 and that the upstream packet 541 does not need to be retransmitted by the first earbud 520-1 to the call gateway 510. In this way, in poor link conditions, by reserving multiple slots 534 in each connection interval 532 during the voice call 530 for downstream and upstream packet transmission, the first earbud 520-1 and the second earbud 520-2 are provided with multiple opportunities to receive the downstream packet 540 and the call gateway 510 is provided with multiple opportunities to receive the upstream packet 541 thereby improving voice call quality.

As discussed above, during the voice call 530, the call gateway 510 and first earbud 520-1 can use up to six slots 534 (i.e., three frames 634) for transmission of the downstream and upstream packets 540, 541 in each connection interval 532 even if the downstream packet 540 is properly received by the first and second earbuds 520-1, 520-2 in a first slot 534 and the upstream packet 541 is properly received by the call gateway 510 in a second slot 534. When the call gateway 510 is connected to an accessory device during the voice call 530, the call gateway 510 can also reserve/use one or more frames for polling and/or otherwise receiving packets from the accessory device at a predetermined polling rate. For example, when the call gateway 510 is connected to the keyboard 630, the call gateway 510 can reserve/use one frame for polling the keyboard 630 at a predetermined rolling rate for the keyboard 630 such as one frame every 11.25 milliseconds. Similarly, when the call gateway 510 is connected to the mouse 640, the call gateway 510 can reserve/use one frame for polling the mouse 640 at a predetermined rolling rate for the mouse 640 such as two frames every 11.25 milliseconds. Also, in order to discover new devices, the call gateway 510 can reserve/use three frames for scanning for new devices at a predetermined scanning rate such as three frames every 22.5 milliseconds. In some embodiments, the polling rates can be determined by the type of accessory device (e.g., a watch, heart rate monitor) that is connected to the call gateway 510. In other embodiments, the polling rates can be determined based on the HID Profile.

In some embodiments, because there is a potential for overlap for traffic between the call gateway 510, the first earbud 520-1, the accessory device(s), and the scanning, the call gateway 510 can implement a traffic prioritization scheme. For example, the call gateway 510 can prioritize traffic between the call gateway 510 and the first earbud 520-1 over the traffic between the call gateway 510 and the accessory device(s) (e.g., the keyboard 630 and mouse 640) and can prioritize scanning for new devices over traffic between the call gateway 510 and the accessory device(s). However, during the voice call 530, implementing a prioritization scheme such as the one described above can increase the bandwidth utilization at the call gateway 510 resulting in polling the accessory device(s) at a reduced rate and/or skipping polling of an accessory device altogether. When the polling rate of an accessory device is reduced and/or the accessory device is not polled, accessory device lag and/or non-responsiveness can occur. For example, as shown in FIG. 6, the call gateway 510 can use the first three frames in each connection interval 532 for traffic 660 between the call gateway 510 and the first earbud 520-1 and the subsequent three frames in each connection interval 532 for other traffic 664, 666 such as polling the keyboard 630 or mouse 640 and performing scans to discover new devices. In this scheme, the call gateway 510 only uses two frames every 22.5 milliseconds for polling the mouse 540 and does not use any frames for polling the keyboard 630. As such, a user may experience lag or non-responsiveness when using the keyboard 530 during the voice call 530 in which the call gateway 510 is connected to the first earbud 520-1.

To overcome the foregoing challenges and others, in some embodiments, an ACK can be included in upstream packets transmitted by the first earbud 520-1 to the call gateway 510. An upstream packet that includes an ACK can serve to indicate to the call gateway 510 that the downstream packet 540 has been properly received by the first earbud 520-1 and that the downstream packet 540 does not need to be retransmitted to the first earbud 520-1 in another slot 534 (e.g., the third and/or fifth slots). The call gateway 510 can then use other reserved slots/frames in the connection interval 532 for other activities (e.g., polling accessory devices and/or performing scans for new devices) thereby reducing bandwidth utilization at the call gateway 510 during the voice call 530.

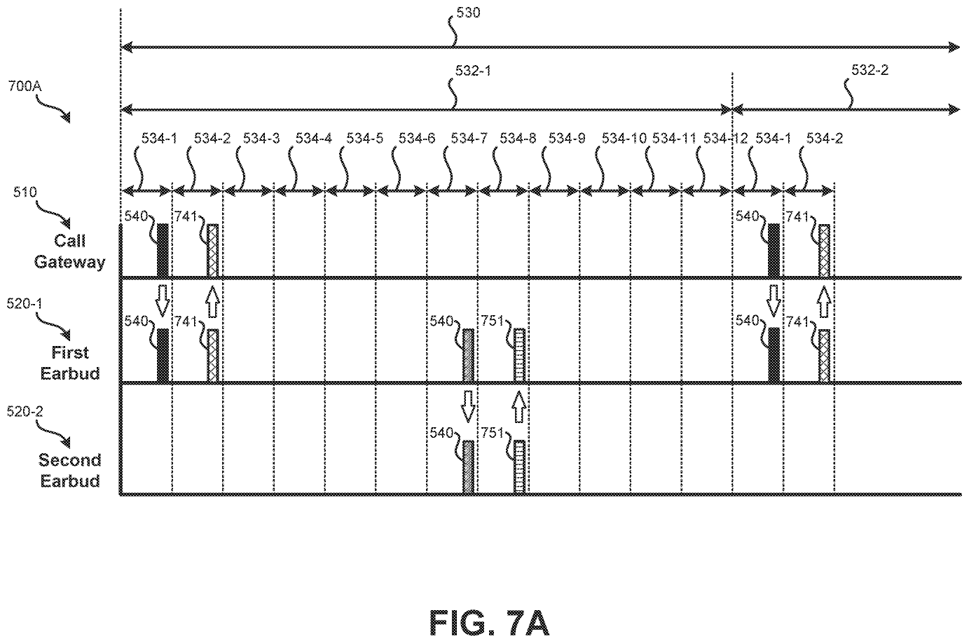

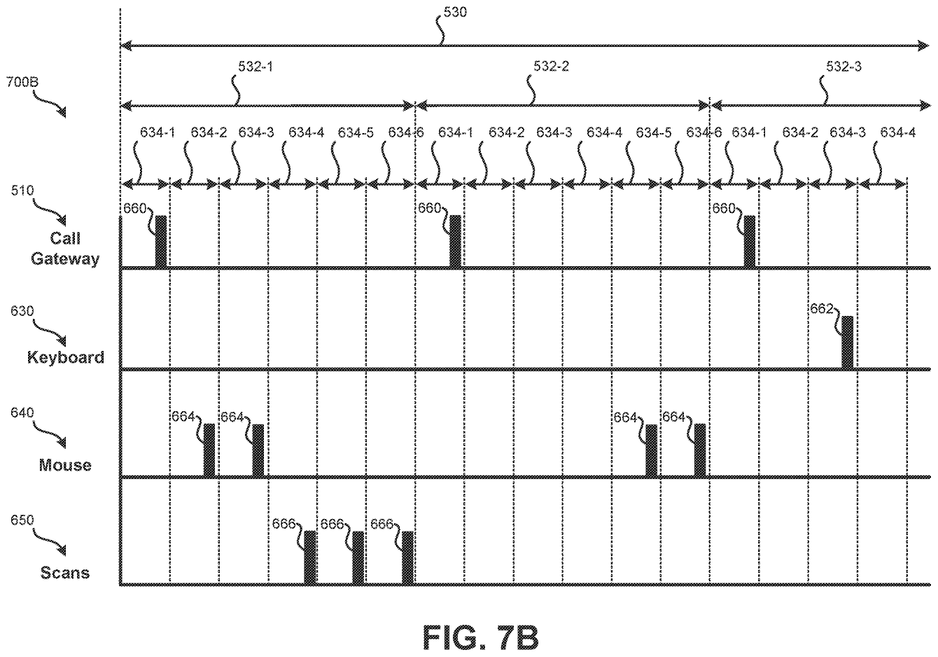

FIG. 7A illustrates an embodiment 700A of communication between the call gateway 510 and true wireless earbuds, including first earbud 520-1 and second earbud 520-2, in which, during the voice call 530, the first earbud 520-1 transmits an upstream packet 741 that includes an ACK to the call gateway 510 in response to properly receiving a downstream packet 540 transmitted by the call gateway 510 (e.g., in the first slot 534-1 in the first connection interval 532-1). The call gateway 510 can treat the upstream packet 741 that includes the ACK as a confirmation that the downstream packet 540 transmitted to the first earbud 520-1 has been properly received by the first earbud 520-1 in a given connection interval 532 and that the downstream packet 540 does not need to be retransmitted in other reserved slots/frames in the given connection interval 532 (e.g., does not need to be retransmitted in the third and fifth slots) to the first earbud 520-1. Because a properly received downstream packet 540 does not need to be retransmitted in other reserved slots/frames, the call gateway 510 can then use the other reserved slots/frames in the connection interval 532 for other traffic (e.g., polling accessory devices and/or performing scans for new devices).

FIG. 7B, which illustrates another embodiment 700B of communication between the call gateway 510 and the keyboard 630 and mouse 640 in which, during the voice call 530, only a single frame in each connection interval 532 is used for traffic 660 between the call gateway 510 and the first earbud 520-1. As shown in FIG. 7B, when only a single frame in each connection interval 532 is used for traffic 660 between the call gateway 510 and the first earbud 520-1, other frames in each connection interval 532 can be reserved/used for other traffic 662, 664, and 666 such as polling the keyboard 630 or mouse 640 and/or performing scans to discover new devices. In this scheme, the call gateway 510 can poll the keyboard 630 once and the mouse 640 four times every 22.5 milliseconds. As such, during the voice call 530 in which the call gateway 510 is connected to the first earbud 520-1, bandwidth utilization at the call gateway 510 during the voice call 530 can be decreased while reducing lag and increasing responsivity of accessory devices also connected to the call gateway 510.

In the foregoing scheme, the second earbud 520-2 is provided with just a single opportunity to intercept and/or otherwise acquire the downstream packet 540 transmitted by the call gateway 510 in each connection interval 534. As described above, in poor link conditions, the second earbud 520-2 may not intercept and/or otherwise acquire the transmitted packet. To ensure the second earbud 520-2 acquires the transmitted packet in a given connection interval 532 in the foregoing scheme, the first earbud 520-1 can transmit a data packet corresponding to a properly received downstream packet 540 in the given connection interval 532 to the second earbud 520-2 and the second earbud 520-2 can transmit an ACK in response to properly receiving the data packet from the first earbud 520-1.

In some embodiments, upon properly receiving the downstream packet 540 from the call gateway 510, the first earbud 520-1 can decode the downstream packet 540 into audio or voice data. The audio or voice data can include audio or voice data for an audio channel associated with the first earbud 520-1 and/or audio or voice data for an audio channel associated with the second earbud 520-1. In some embodiments, the audio or voice data can include audio or voice for an audio channel associated with both the first and second earbuds 520-1, 520-2. Upon decoding the downstream packet 540, the first earbud 520-1 can generate data packets from the audio or voice data. In some embodiments, the first earbud 520-1 generates the data packets by dividing the audio or voice data into pieces of audio or voice data and the pieces of audio or voice data are transmitted from the first earbud 520-1 to the second earbud 520-2 as the data packets. In other embodiments, the first earbud 520-1 can generate the data packets by dividing the audio or voice data into pieces of audio or voice data and encrypting and/or packetizing the pieces of audio or voice data and the encrypted and packetized audio or voice data is transmitted from the first earbud 520-1 to the second earbud 520-2 as the data packets.

In some embodiments, for a given connection interval 532, the first and second earbuds 520-1, 520-2 can reserve/use two slots in the given connection interval 532 for first earbud 520-1 to transmit a data packet corresponding to the properly received downstream packet 540 to the second earbud 520-2 and for the second earbud 520-2 to transmit an ACK to the first earbud 520-1 in response to properly receiving the data packet from the first earbud 520-1. For example, as shown in FIG. 7A, in a given connection interval 532, the first and second earbuds 520-1, 520-2 can reserve/use the seventh and eighths slots (e.g., slots 534-7, 534-8 in the first connection interval 532-1) for the first earbud 520-1 to transmit a data packet 540 corresponding to the properly received downstream packet 540 to the second earbud 520-2 and for the second earbud 520-2 to transmit an ACK 751 to the first earbud 520-1 in response to properly receiving the data packet from the first earbud 520-1. In some embodiments, prior to forwarding the properly received downstream packet 540, the first earbud 520-1 can poll and/or otherwise handshake with the second earbud 520-2 to determine whether the second earbud 520-1 properly intercepted and/otherwise acquired the downstream packet 540 transmitted by the call gateway 510. The first earbud 520-1 can transmit the data packet 540 corresponding to the properly received downstream packet 540 to the second earbud 520-2 if it is determined that the second earbud 520-2 did not intercept and/or was otherwise unable to properly acquire the downstream packet 540 transmitted by the call gateway 510. In this way, because the second earbud 520-2 is provided with the opportunity to acquire the downstream packet 540 from either the call gateway 510 and/or the first earbud 520-1, voice call quality during the voice call can be improved even in poor link conditions along with reducing bandwidth utilization at the call gateway 510.

The foregoing scheme is not intended to be limiting and other arrangements such as a rotating ACK scheme can be implemented. In a rotating ACK scheme, an ACK can be periodically included in upstream packets transmitted by the first earbud 520-1 to the call gateway 510. In some embodiments, an ACK can be included in upstream packets transmitted by the first earbud 520-1 in every other connection interval 532, every third connection interval 532, every fourth connection interval 532, and so on. In connection intervals 532 in which an ACK is included in upstream packets transmitted by the first earbud 520-1, only a single frame in each connection interval 532 can be used for traffic between the call gateway 510 and the first earbud 520-1. In connection intervals 532 in which upstream packets transmitted by the first earbud 520-1 include a NACK or the first earbud 520-1 does not transmit an upstream packet, multiples frames in each connection interval 532 can be used for traffic between the call gateway 510 and the first earbud 520-1.

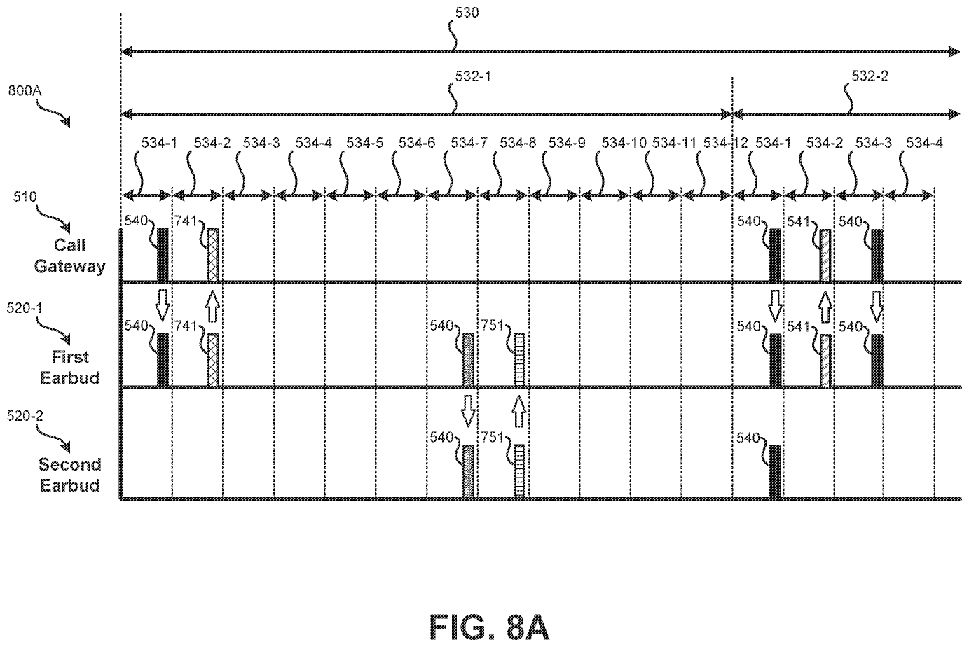

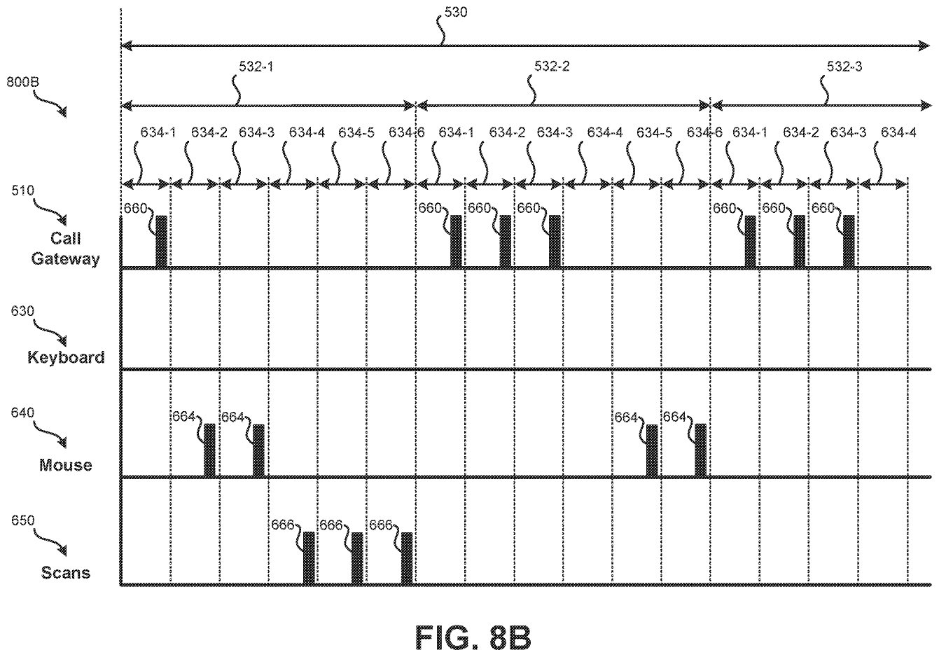

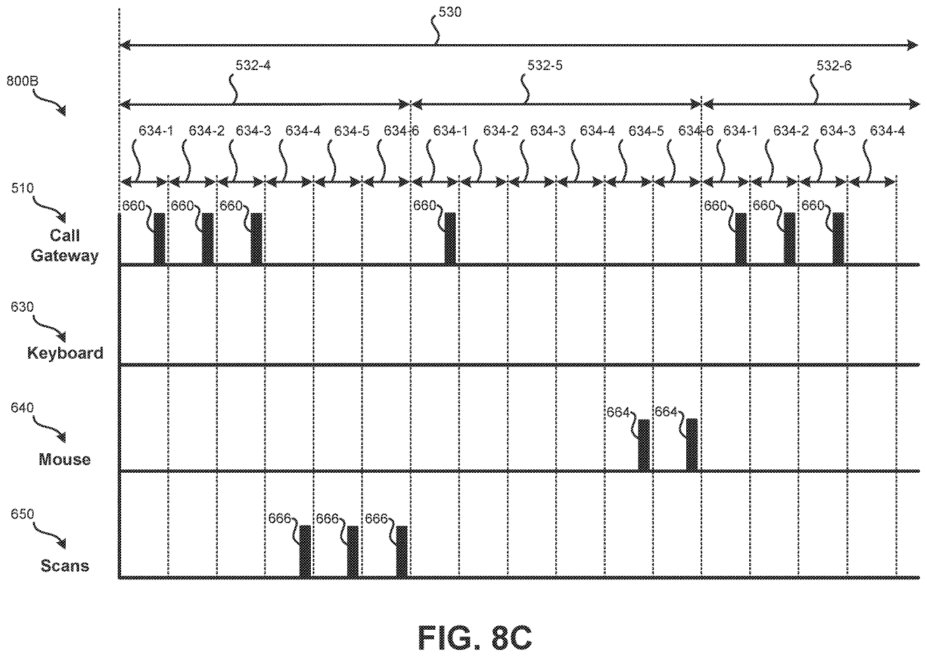

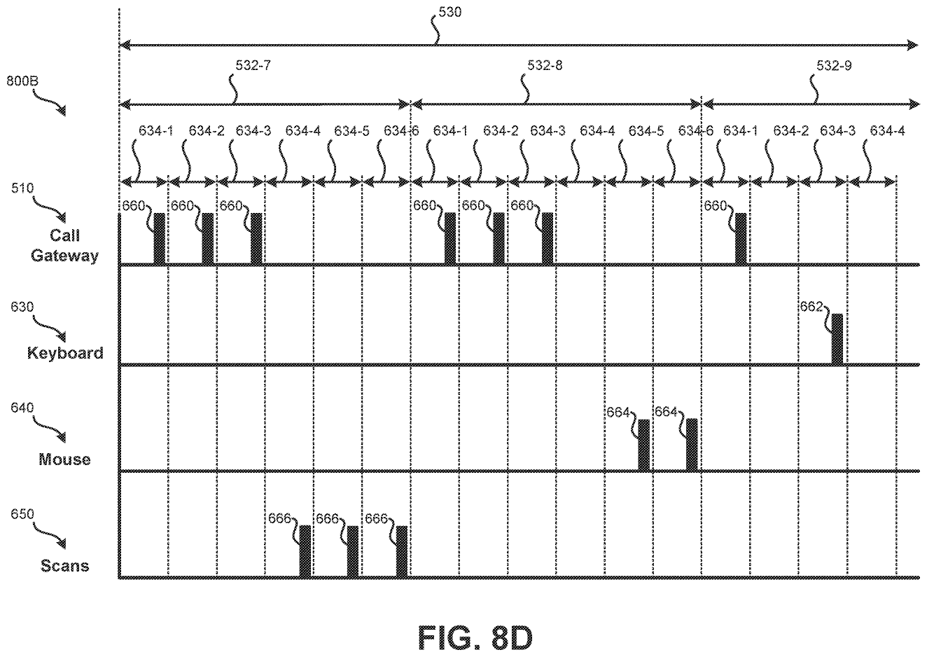

FIG. 8A illustrates an embodiment 800A of communication between the call gateway 510 and true wireless earbuds, including first earbud 520-1 and second earbud 520-2, in which, during the voice call 530, the first earbud 520-1 periodically transmits an upstream packet 741 that includes an ACK to the call gateway 510 in response to properly receiving a downstream packet 540 transmitted by the call gateway 510 (e.g., in the first slot 534). In some embodiments, the voice call 530 can include multiple windows (not shown). Each window of the voice call 530 can span a length of time (e.g., 67.5 milliseconds). In some embodiments, for each window of the voice call 530, the first earbud 520-1 can transmit an upstream packet 741 that includes an ACK to the call gateway 510 in response to properly receiving a downstream 540 transmitted by the call gateway 510 in the first connection interval 532 of the respective window and in every fourth connection interval 532 thereafter of the respective window. For example, for a given window, the first earbud 520-1 can transmit an upstream packet 741 that includes an ACK to the call gateway 510 in the first connection interval 532 of the given window, in the fifth connection interval 532 of the given window, and in the ninth connection interval 532 of the given window. As shown in FIG. 8A, in the first connection interval 532, the first earbud 520-1 transmits an upstream packet 741 that includes an ACK to the call gateway 510 in response to properly receiving a downstream packet 540 transmitted by the call gateway 510 (e.g., in the first slot 534). As further shown in FIG. 8A, in the second connection interval 532, the first earbud 520-1 transmits an upstream packet 541 that includes a NACK to the call gateway 510 in response to properly receiving a downstream packet 540 transmitted by the call gateway 510. In this way, voice call quality can be improved while balancing bandwidth utilization in the call gateway 510 during the voice call 530.

FIG. 8B-8D, which illustrates an embodiment 800B of communication between the call gateway 510 and the keyboard 630 and mouse 640 in which, during the voice call 530, only a single frame in the first connection interval 532 and in every fourth connection interval 532 thereafter is reserved/used for traffic 660 between the call gateway 510 and the first earbud 520-1 in a given window of the voice call 530. As shown in FIGS. 8B-8D, by reserving/using a single frame for traffic 660 between the call gateway 510 and the first earbud 520-1 in the first connection interval 532 and in every fourth connection interval 532 thereafter in a given window, frames in the respective connection intervals 532 can be reserved/used for other traffic 662, 664, and 666 such as polling the keyboard 630 or mouse 640 and/or performing scans to discover new devices. Similarly, by reserving/using multiple frames for traffic 660 between the call gateway 510 and the first earbud 520-1 in the remaining connection intervals 532, other frames in the remaining connection intervals 532 can be reserved/used for retransmission of the downstream packets 540 and upstream packets 741. In this scheme, the call gateway 510 can poll the keyboard 630 at least once every 67.5 milliseconds and the mouse 640 at least once every 22.5 milliseconds. As such, during the voice call 530 in which the call gateway 510 is connected to the first earbud 520-1, bandwidth utilization at the call gateway 510 during the voice call 530 can be decreased while reducing lag and increasing responsivity of accessory devices also connected to the call gateway 510.

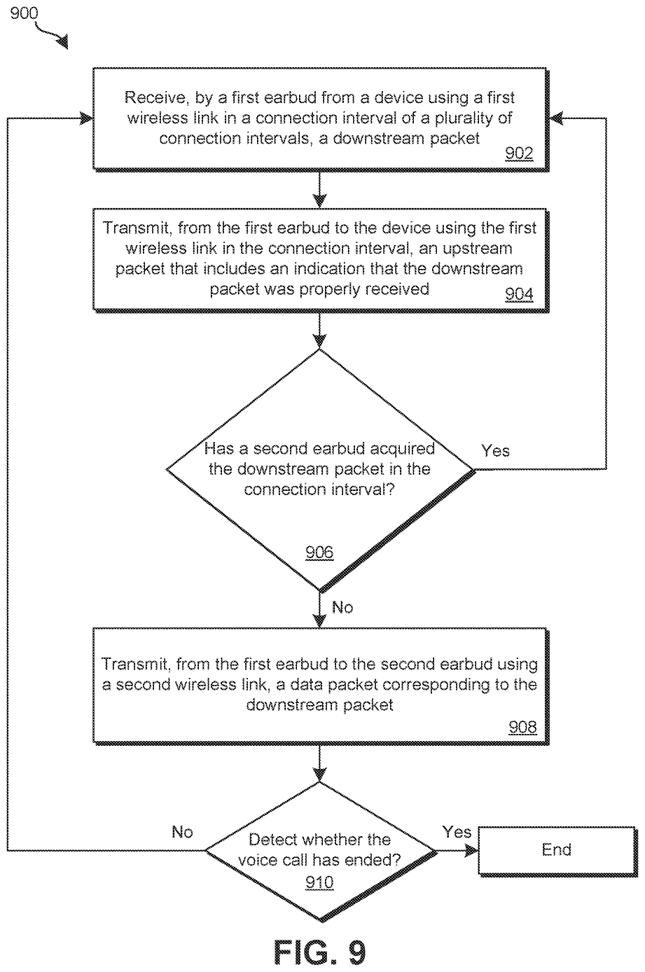

FIG. 9 illustrates an embodiment of a method 900 corresponding to the embodiments of FIGS. 7A and 7B. The processing depicted in FIG. 9 may be implemented in software (e.g., code, instructions, program) executed by a processing system such as a processing system of the call gateway 510 and/or the first earbud 520-1. The software may be stored on a non-transitory computer-readable storage medium (e.g., a memory device). The method 900 is intended to be illustrative and non-limiting. For example, although FIG. 9 depicts the various processing steps occurring in a particular sequence or order, in other embodiments, the steps may be performed in some different order or some steps may also be performed in parallel.

At block 902, a downstream packet is received by a first earbud of a set of earbuds from a device using a first wireless link in a connection interval of a plurality of connection intervals. In some embodiments, the connection interval includes a plurality of slots and the downstream packet is received in a first slot of the plurality of slots. In some embodiments, the first wireless link is a Bluetooth Basic Rate/Enhanced Data Rate (Bluetooth BR/EDR) link.

At block 904, an upstream packet is transmitted from the first earbud to the device using the first wireless link in the connection interval. The upstream packet includes an indication that the downstream packet was properly received. In some embodiments, the upstream packet also includes voice information of a user participating in a voice call using the set of earbuds. In some embodiments, the upstream packet is transmitted in a second slot of the plurality of slots, where the second slot is adjacent to the first slot in the connection interval.

At block 906, a determination is made by the first earbud and a second earbud of the set of earbuds whether the second earbud has acquired the downstream packet in the connection interval. In response to determining that the second earbud has acquired the downstream packet in the connection interval, the method reverts to block 902 in which another downstream packet is received by the first earbud from the device using the first wireless link in another connection interval of the plurality of connection intervals. In response to determining that the second earbud has not acquired the downstream packet in the connection interval, the method proceeds to block 908.

At block 908, a data packet corresponding to the downstream packet is transmitted from the first earbud to the second earbud using a second wireless link. In some embodiments, the second wireless link is a Bluetooth Low Energy Link.

At block 910, a check is made whether the voice call has ended. In response to determining that the voice call has not ended, the method reverts to block 902 in which another downstream packet is received from the device using the first wireless link in another connection interval of the plurality of connection intervals. In response to determining that the voice call has ended, the method ends.

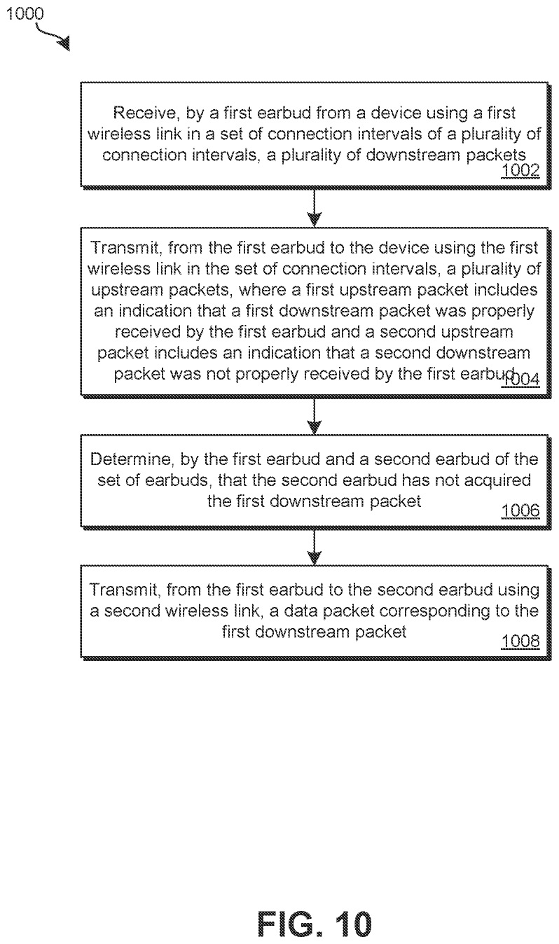

FIG. 10 illustrates an embodiment of a method 1000 corresponding to the embodiments of FIGS. 8A-8D. The processing depicted in FIG. 10 may be implemented in software (e.g., code, instructions, program) executed by a processing system such as a processing system of the call gateway 510 and/or the first earbud 520-1. The software may be stored on a non-transitory computer-readable storage medium (e.g., a memory device). The method 1000 is intended to be illustrative and non-limiting. For example, although FIG. 10 depicts the various processing steps occurring in a particular sequence or order, in other embodiments, the steps may be performed in some different order or some steps may also be performed in parallel.

At block 1002, a plurality of downstream packets is received by a first earbud of a set of earbuds from a device using a first wireless link in a set of connection intervals of a plurality of connection intervals. In some embodiments, each downstream packet of the plurality of downstream packets is received in a first slot of a plurality of slots of each connection interval of the set of connection intervals. In some embodiments, the first wireless link is a Bluetooth Basic Rate/Enhanced Data Rate (Bluetooth BR/EDR) link.

At block 1004, a plurality of upstream packets is transmitted from the first earbud to the device using the first wireless link in the set of connection intervals. In some embodiments, each upstream packet of the plurality of upstream packets is transmitted in a second slot of the plurality of slots of each connection interval of the set of connection intervals wherein the second slot of a respective connection interval of the set of connection intervals is adjacent to the first slot of the respective connection interval. In some embodiments, a first upstream packet of the plurality of upstream packets includes an indication that a first downstream packet of the plurality of downstream packets was properly received by the first earbud. In some embodiments, a second upstream packet of the plurality of upstream packets includes an indication that a second downstream packet of the plurality of downstream packets was not properly received by the first earbud. In some embodiments, each first upstream packet of the plurality of first upstream packets includes voice information of a user participating in a voice call using the set of earbuds.

At block 1006, a determination is made by the first earbud and a second earbud of the set of earbuds that the second earbud has not acquired the first downstream packet.

At block 1008, a data packet corresponding to the first downstream packet is transmitted from the first earbud to the second earbud using a second wireless link. In some embodiments, the second wireless link is a Bluetooth Low Energy link. In some embodiments, the data packet corresponding to the first downstream packet is transmitted from the first earbud to the second earbud using the second wireless link in response to determining that the second earbud has not acquired the first downstream packet.

The systems and methods of the present disclosure may be implemented using hardware, software, firmware, or a combination thereof and may be implemented in one or more computer systems or other processing systems. Some embodiments of the present disclosure include a system including a processing system that includes one or more processors. In some embodiments, the system includes a non-transitory computer readable storage medium containing instructions which, when executed on the one or more processors, cause the system and/or the one or more processors to perform part or all of one or more methods and/or part or all of one or more processes disclosed herein. Some embodiments of the present disclosure include a computer-program product tangibly embodied in a non-transitory machine-readable storage medium, including instructions configured to cause the system and/or the one or more processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

What is claimed is:

1. A method for controlling a set of earbuds, the method comprising:
receiving, by a first earbud of the set of earbuds from a device using a first wireless link in a set of connection intervals of a plurality of connection intervals, a plurality of downstream packets; and
transmitting, from the first earbud to the device using the first wireless link in the set of connection intervals, a plurality of upstream packets, wherein a first upstream packet of the plurality of upstream packets comprises an indication that a first downstream packet of the plurality of downstream packets was properly received by the first earbud, and wherein a second upstream packet of the plurality of upstream packets comprises an indication that a second downstream packet of the plurality of downstream packets was not properly received by the first earbud.

2. The method of claim 1, wherein the first wireless link is a Bluetooth Basic Rate/Enhanced Data Rate (Bluetooth BR/EDR) link.

3. The method of claim 1, further comprising:
determining, by the first earbud and a second earbud of the set of earbuds, that the second earbud has not acquired the first downstream packet; and
in response to determining that the second earbud has not acquired the first downstream packet, transmitting, from the first earbud to the second earbud using a second wireless link, a data packet corresponding to the first downstream packet.

4. The method of claim 3, wherein the second wireless link is a Bluetooth Low Energy link.

5. The method of claim 1, wherein each upstream packet of the plurality of upstream packets comprises voice information of a user participating in a voice call using the set of earbuds.

6. The method of claim 1, wherein each downstream packet of the plurality of downstream packets is received in a first slot of a plurality of slots of each connection interval of the set of connection intervals.

7. The method of claim 6, wherein each upstream packet of the plurality of upstream packets is transmitted in a second slot of the plurality of slots of each connection interval of the set of connection intervals, the second slot of a respective connection interval of the set of connection intervals adjacent to the first slot of the respective connection interval.

8. A system comprising:
a processing system; and
a computer-readable medium storing instructions which, when executed by the processing system, cause the system to perform a method comprising:
receiving, by a first earbud of a set of earbuds from a device using a first wireless link in a set of connection intervals of a plurality of connection intervals, a plurality of downstream packets; and
transmitting, from the first earbud to the device using the first wireless link in the set of connection intervals, a plurality of upstream packets, wherein a first upstream packet of the plurality of upstream packets comprises an indication that a first downstream packet of the plurality of downstream packets was properly received by the first earbud, and wherein a second upstream packet of the plurality of upstream packets comprises an indication that a second downstream packet of the plurality of downstream packets was not properly received by the first earbud.

9. The system of claim 8, wherein the first wireless link is a Bluetooth Basic Rate/Enhanced Data Rate (Bluetooth BR/EDR) link.

10. The system of claim 8, further comprising:
determining, by the first earbud and a second earbud of the set of earbuds, that the second earbud has not acquired the first downstream packet; and
in response to determining that the second earbud has not acquired the first downstream packet, transmitting, from the first earbud to the second earbud using a second wireless link, a data packet corresponding to the first downstream packet.

11. The system of claim 10, wherein the second wireless link is a Bluetooth Low Energy link.

12. The system of claim 8, wherein each upstream packet of the plurality of upstream packets comprises voice information of a user participating in a voice call using the set of earbuds.

13. The system of claim 8, wherein each downstream packet of the plurality of downstream packets is received in a first slot of a plurality of slots of each connection interval of the set of connection intervals.

14. The system of claim 13, wherein each upstream packet of the plurality of upstream packets is transmitted in a second slot of the plurality of slots of each connection interval of the set of connection intervals, the second slot of a respective connection interval of the set of connection intervals adjacent to the first slot of the respective connection interval.

15. A non-transitory computer-readable media storing instructions which, when executed by a processing system of an earbud, cause the earbud to perform a method comprising:
receiving, by a first earbud of a set of earbuds from a device using a first wireless link in a set of connection intervals of a plurality of connection intervals, a plurality of downstream packets; and
transmitting, from the first earbud to the device using the first wireless link in the set of connection intervals, a plurality of upstream packets, wherein a first upstream packet of the plurality of upstream packets comprises an indication that a first downstream packet of the plurality of downstream packets was properly received by the first earbud, and wherein a second upstream packet of the plurality of upstream packets comprises an indication that a second downstream packet of the plurality of downstream packets was not properly received by the first earbud.

16. The non-transitory computer-readable medium of claim 15, wherein the first wireless link is a Bluetooth Basic Rate/Enhanced Data Rate (Bluetooth BR/EDR) link.

17. The non-transitory computer-readable medium of claim 15, further comprising:
determining, by the first earbud and a second earbud of the set of earbuds, that the second earbud has not acquired the first downstream packet; and
in response to determining that the second earbud has not acquired the first downstream packet, transmitting, from the first earbud to the second earbud using a second wireless link, a data packet corresponding to the first downstream packet.

18. The non-transitory computer-readable medium of claim 15, wherein each upstream packet of the plurality of upstream packets comprises voice information of a user participating in a voice call using the set of earbuds.

19. The non-transitory computer-readable medium of claim 15, wherein each downstream packet of the plurality of downstream packets is received in a first slot of a plurality of slots of each connection interval of the set of connection intervals.

20. The non-transitory computer-readable medium of claim 19, wherein each upstream packet of the plurality of upstream packets is transmitted in a second slot of the plurality of slots of each connection interval of the set of connection intervals, the second slot of a respective connection interval of the set of connection intervals adjacent to the first slot of the respective connection interval.
